(19) United States
(12) Patent Application Publication
(10) Pub. No.: US 2016/0064915 A1
(43) Pub. Date: Mar. 3, 2016

(54) CIRCUIT BREAKER FOR INTERRUPTING A CIRCUIT

(71) Applicant: Siemens Aktiengesellschaft, Munchen (DE)

(72) Inventor: Bernd SCHWINN, Fuerth (DE)

(21) Appl. No.: 14/799,604

(22) Filed: Jul. 15, 2015

(30) Foreign Application Priority Data
Aug. 29, 2014 (DE) 102014217292.6

(51) Int. Cl. H02H 3/00; H02H 1/00

(52) U.S. Cl. CPC H02H 3/00; H02H 1/0084

(57) ABSTRACT

A circuit breaker is disclosed for interrupting a circuit. In an embodiment, the circuit breaker includes an electronic trip element, including a microcontroller, to interrupt the electrical circuit when at least one adjustable protection parameter is reached. The microcontroller of the electronic trip element is connected to a radio module that is at least intermittently wirelessly connected to a terminal. The microcontroller, the radio module and the terminal are embodied such that protection parameters are displayable and adjustable and operating states are displayable on the terminal.

### PRIORITY STATEMENT

The present application hereby claims priority under 35 U.S.C. §119 to German patent application number DE 102014217292.6 filed Aug. 29, 2014, the entire contents of which are hereby incorporated herein by reference.

### FIELD

At least one embodiment of the present invention generally relates to a circuit breaker, a terminal, a method, a software program product and/or a system.

### BACKGROUND

Circuit breakers are special switches that are designed for switching high currents. Not only can they switch operating currents and small overload currents, they can also switch high overload currents or short-circuit currents in the event of faults. They can additionally hold fault currents for a prescribed time and safely disconnect them. There are circuit breakers with different numbers of poles, such as single pole, two pole, three pole or four pole, etc.

Apart from use as a simple switching element, circuit breakers are used as line protection in the event of faults such as short circuit, overcurrent, leakage current or ground fault.

Circuit breakers, such as molded case circuit breakers, air circuit breakers, are used on different distribution levels in power distribution, such as main distribution, subdistribution. In order to optimize the circuit breakers in their task of protecting the power distribution and the loads, it is possible to use protection parameters, e.g. for protection against overload, short-time-delay short circuit protection, zero-delay short circuit protection, protection against leakage currents to ground, protection of the neutral conductor, etc. These protection parameters are adjustable at the device in terms of their type and magnitude. So that no unauthorized persons are able to alter the adjusted parameters, the relevant adjusting elements are safeguarded by a lead seal or a sealing device.

Mechanical adjusting options for the parameters of a trip element, such as an electronic trip unit, ETU for short, of the circuit breaker are known, e.g. by virtue of rotary coding switches. Disadvantages in this case are the very expensive components, the production and testing of the rotary coding switches on the board and limited adjusting options on account of the limited space on the trip element (few parameters, large interval steps).

Additionally known are adjusting options for a trip element by way of keys and display. A disadvantage in this case is also the high costs of a display. In addition, it is frequently not possible to use a display at high and very low temperatures. Furthermore, it is often possible for only very few data or parameters to be displayed on the display or a very complicated menu structure is required that is disadvantageous for operators, particularly if they adjust the parameters only rarely.

Both mechanical adjusting options, e.g. using rotary code switches, and adjustment using keys and a display frequently require further components and shielding measures, for example vis-àa-vis electromagnetic compatibility, EMC for short. These increase the cost of production of a trip element or an ETU.

Switching devices, particularly circuit breakers, can adopt various operating states or statuses such as on, off, tripped. In addition, it can provide and display further information regarding the switch status, e.g. reason for tripping, notification of maintenance, etc.

### SUMMARY

At least one embodiment of the present invention is directed to the display of operating states and/or the adjustment and display of protection parameters of a circuit breaker.

At least one embodiment is achieved for adjustment and display of protection parameters by a circuit breaker, and/or for the display of operating states by a circuit breaker. In addition, a terminal, a method, a software program product and a system are disclosed.

According to at least one embodiment of the invention, the circuit breaker has a radio module that is connected to the microcontroller of the electronic trip element and can be at least intermittently wirelessly connected to a terminal. This arrangement is embodied such that a terminal can be used to display and adjust protection parameters or to display operating states of the switch. This has the particular advantage that it is possible to dispense with a display and adjusting elements at the circuit breaker. In addition, no lines are required for connecting an external terminal or for a control or display unit.

According to at least one embodiment of the invention, the circuit breaker includes an electronic trip element, including a microcontroller, to interrupt the electrical circuit when at least one adjustable protection parameter is reached, the microcontroller of the electronic trip element being connected to a radio module, at least intermittently wirelessly connectable to a terminal, the microcontroller and the radio module being embodied such that displayable and adjustable protection parameters are transmittable to the terminal.

According to at least one embodiment of the invention, the circuit breaker includes an electronic trip element, including a microcontroller, to interrupt the electrical circuit when at least one adjustable protection parameter is reached, the microcontroller of the electronic trip element being connected to a radio module, at least intermittently wirelessly connectable to a terminal, the microcontroller and the radio module being embodied such that operating states of the circuit breaker are transmittable to the terminal.

According to at least one embodiment of the invention, the circuit breaker includes an electronic trip element, including a microcontroller, to interrupt the electrical circuit when at least one adjustable protection parameter is reached, the microcontroller of the electronic trip element being connected to a radio module, at least intermittently wirelessly connectable to a terminal, the microcontroller and the radio module being embodied such that displayable and adjustable protection parameters and displayable operating states are transmittable to the terminal.

According to at least one embodiment of the invention, a method is disclosed for a circuit breaker, including an electronic trip element, including a microcontroller, to interrupt at least one electrical circuit when at least one adjustable protection parameter is reached, and a terminal, the method comprising:

using a wireless connection, between a radio module connected to the microcontroller of the electronic trip element and the terminal, to transmit protection parameters of the circuit breaker that are displayable and adjustable on the terminal.

According to at least one embodiment of the invention, a method is disclosed for a circuit breaker, including an electronic trip element, including a microcontroller, to interrupt at least one electrical circuit when at least one adjustable protection parameter is reached, and a terminal, the method comprising:

using a wireless connection, between a radio module connected to the microcontroller of the electronic trip element and the terminal, to transmit operating states of the circuit breaker that are displayable on the terminal.

According to at least one embodiment of the invention, a software program product is disclosed for a terminal to, when executed on a device, implement at least one embodiment of the method.

### BRIEF DESCRIPTION OF THE DRAWINGS

An example embodiment of the invention is shown in the drawings and is described in more detail below. In the drawings:

FIG. 1 shows a representation of a circuit breaker,

FIG. 2 shows a representation of a trip element with mechanical adjusting options,

FIG. 3 shows a representation of a trip element with a display,

FIG. 4 shows a representation of a terminal.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

According to at least one embodiment of the invention, the circuit breaker has a radio module that is connected to the microcontroller of the electronic trip element and can be at least intermittently wirelessly connected to a terminal. This arrangement is embodied such that a terminal can be used to display and adjust protection parameters or to display operating states of the switch. This has the particular advantage that it is possible to dispense with a display and adjusting elements at the circuit breaker. In addition, no lines are required for connecting an external terminal or for a control or display unit.

Advantageous embodiments of the invention are specified in the subclaims and in the example embodiment.

In one advantageous embodiment of the invention, the terminal is a mobile terminal, such as a smart phone, laptop, etc.

On this terminal, there is provision not only for a further radio function but also for a software program product that is embodied such that operating states can be displayed and/or protection parameters can be displayed and adjusted. The display and/or adjustment can be safeguarded by a password that is set in the terminal and/or circuit breaker. This has the particular advantage that a service engineer or startup engineer can conveniently read and adjust the operating states or protection parameters, data for short.

In this case, it is possible, by way of example, for the size of the presentation to be adjusted arbitrarily, e.g. by virtue of different fonts. In addition, the data on the display of the terminal can be displayed in more detail and adjusted more finely. The granularity can be increased by the software used.

In one advantageous embodiment of the invention, the terminal is a static terminal, for example a display of the operating state or of the protection parameters in the room in which the circuit breaker is arranged. This has the particular advantage that clear and fast display of the data is made possible without paying a direct visit to the circuit breaker in the first step. Furthermore, installation without any cables is possible.

In one advantageous embodiment of the invention, the static terminal is arranged on a switchgear cabinet. This has the particular advantage that display of the data of a circuit breaker is made possible without opening the switchgear cabinet that contains the circuit breaker, for example. In addition, installation without complex laying of cables is possible.

In one advantageous embodiment of the invention the wireless connection is a Bluetooth connection. This has a particular advantage that frequently available wireless technology is available for the transmission.

In one advantageous embodiment of the invention, the wireless connection is encrypted or the data on the connection are encrypted. This has the particular advantage that manipulation of the display data or the parameters that are to be adjusted is rendered more difficult.

In one advantageous embodiment of the invention, the display and/or adjustment of the protection parameters is safeguarded, e.g. by way of a password. This has the particular advantage that display of the data or alteration of the parameters is made possible only for authorized persons.

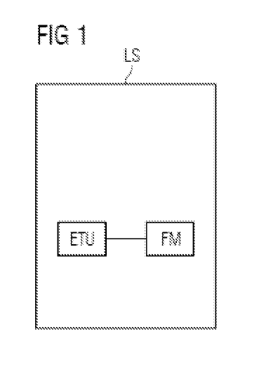

FIG. 1 shows a basic representation of a circuit breaker LS, having an electronic trip element ETU, such as an electronic trip unit. The latter has a microprocessor, which is not shown. According to the invention, the circuit breaker has a radio module FM that is connected to the trip element ETU or to the microcontroller of the trip element. The radio module is secondly at least intermittently wirelessly connected to a terminal that is not shown in FIG. 1. This connection can be made directly, or else indirectly, for example via a communication network (not shown), such as a mobile radio network, wireless LAN network, mesh and/or ad-hoc network, to further network nodes and/or components, etc.

The circuit breaker is arranged in at least one electrical circuit, not shown, and interrupts the electrical circuit if an adjustable protection parameter, such as an overcurrent, short-circuit current, leakage current and/or ground fault current, that is above a threshold value arises.

The circuit breaker may be an air circuit breaker, for example.

The circuit breaker may be a molded case circuit breaker, for example.

The circuit breaker may be a miniature circuit breaker, for example.

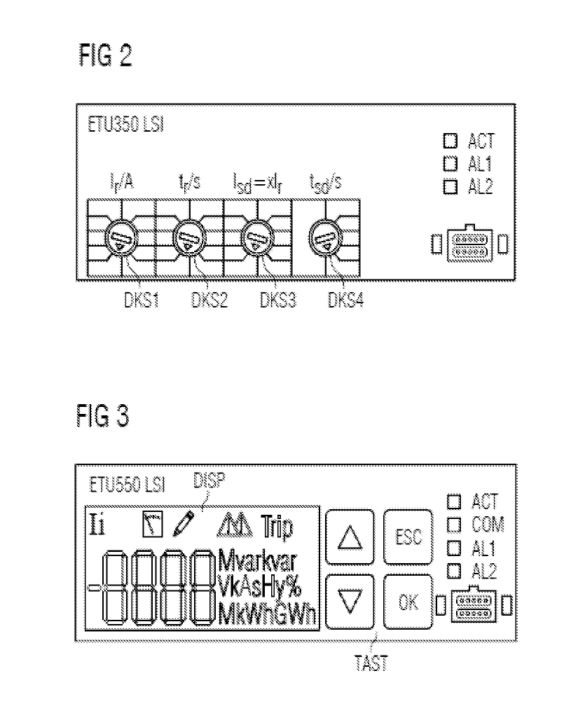

FIG. 2 shows a representation of a control panel for a trip element with mechanical adjusting options for protection parameters. In this case, the protection parameters of the circuit breaker can be adjusted using rotary coding switches DKS1, DKS2, DKS3, DKS4.

FIG. 3 shows a representation of a control panel for a trip element with a display DISP and menu keys TAST for displaying and adjusting the protection parameters. Operating states can be displayed by way of the display DISP and/or by way of light-emitting display elements.

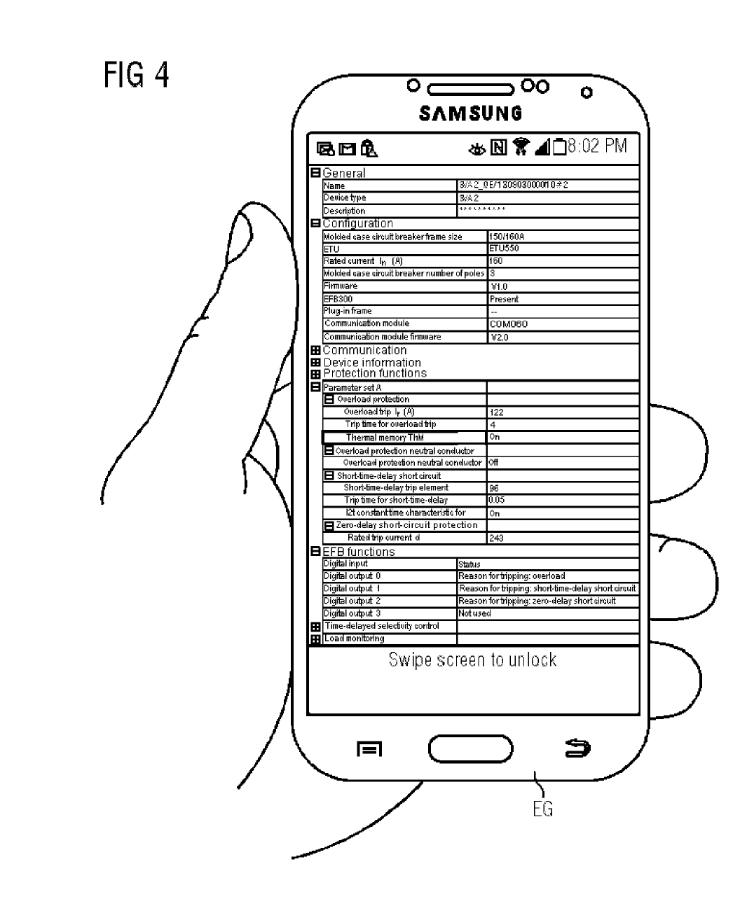

FIG. 4 shows a representation of a terminal EG that is connected to the radio module FM shown in FIG. 1, for example. In the example shown in FIG. 4, the terminal is a smart phone having a large display surface and user interface. This can be used to display and adjust numerous operating states and protection parameters in any resolution.

The terminal has a software program product installed on it that displays data, such as operating states and protection parameters. In addition, protection parameters in altered form can be transmitted to the circuit breaker. The software program product may be what is known as APP, for example.

An embodiment of the present invention will be explained below.

The electronic trip element is provided with a radio function, for example exclusively for the short range. The radio function is used to send the data to a terminal, e.g. a mobile terminal. On the terminal, e.g. a smart phone or tablet, a software program product or a piece of software is provided that can be used to read, present and if need be alter the data from the trip element. The altered data can be transmitted to the circuit breaker.

This means that it is possible to dispense with mechanical components, such as a display or rotary coding switch, at the circuit breaker. The electronic trip element of the circuit breaker can be significantly simplified.

The radio module or the radio communication interface can be used to hold a temporary or permanent communication with a fixed receiving unit, e.g. on or in a switchgear cabinet. This receiving unit may also be a mediator for or in a site-wide power manager and/or power control system. A further advantage in this case is that the cabling is dispensed with or simplified.

An example of a radio technology in the short range would be Bluetooth, for example. This would already be included in smart phones or tablets as possible terminals.

A smart phone, a software program product or piece of software that allows simple parameterization and a Bluetooth connection allow realization.

The advantage resides in the replacement of the expensive adjusting options for the parameters of the trip element by way of mechanical devices or a display at the front with a radio option for a terminal. As a result, simple parameterization by way of software interfaces is possible, larger fonts can be used, more parameters can be adjusted, and this can be done using finer granularity. Communication cabling can be dispensed with.

The radio module or the radio communication can be used in order to transmit status reports, such as on, off, tripped, and warnings and measured values, such as current, voltage, power, to a superordinate management system, such as automation system or power management system.

The electronic trip element can be greatly simplified. Since the adjusting options on the front are dispensed with, no EMC measures are required therefor.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A circuit breaker for interrupting at least one electrical circuit, comprising:
an electronic trip element, including a microcontroller, to interrupt the electrical circuit when at least one adjustable protection parameter is reached, the microcontroller of the electronic trip element being connected to a radio module, at least intermittently wirelessly connectable to a terminal, the microcontroller and the radio module being embodied such that displayable and adjustable protection parameters are transmittable to the terminal.

2. A circuit breaker for interrupting at least one electrical circuit, comprising:
an electronic trip element, including a microcontroller, to interrupt the electrical circuit when at least one adjustable protection parameter is reached, the microcontroller of the electronic trip element being connected to a radio module, at least intermittently wirelessly connectable to a terminal, the microcontroller and the radio module being embodied such that operating states of the circuit breaker are transmittable to the terminal.

3. A circuit breaker for interrupting at least one electrical circuit, comprising:
an electronic trip element, including a microcontroller, to interrupt the electrical circuit when at least one adjustable protection parameter is reached, the microcontroller of the electronic trip element being connected to a radio module, at least intermittently wirelessly connectable to a terminal, the microcontroller and the radio module being embodied such that displayable and adjustable protection parameters and displayable operating states are transmittable to the terminal.

4. The circuit breaker of claim 1, wherein the circuit breaker is a molded case circuit breaker.

5. The circuit breaker of claim 1, wherein the circuit breaker is an air circuit breaker.

6. The circuit breaker of claim 1, wherein the circuit breaker is a miniature circuit breaker.

7. The circuit breaker of claim 1, wherein the wireless connection is a Bluetooth connection.

8. The circuit breaker of claim 1, wherein the wireless connection is encrypted.

9. The circuit breaker of claim 1, wherein At least one of the display and adjustment of the protection parameters is safeguarded.

10. A terminal comprising:
first circuitry to intermittently implement a wireless connection to at least one of a further terminal and a radio module; and
second circuitry to present data transmittable via the wireless connection, wherein the first and second circuitry are additionally embodied to interact with the circuit breaker of claim 1.

11. The terminal of claim 10, wherein the second circuitry are embodied such that the presented data are transmittable back to the circuit breaker at least in part in altered form.

12. The terminal of claim 10, wherein the second circuitry are embodied such that at least one of the presentation of the data and alteration of the data are realized by a software program product.

13. The terminal of claim 10, wherein the terminal is a mobile terminal.

14. The terminal of claim 10, wherein the terminal is a static terminal.

15. The terminal of claim 14, wherein the static terminal is arranged on a switchgear cabinet.

16. The terminal of claim 14, wherein the static terminal is functionally integrated in a power management control system.

17. A method for a circuit breaker, including an electronic trip element, including a microcontroller, to interrupt at least one electrical circuit when at least one adjustable protection parameter is reached, and a terminal, the method comprising:
using a wireless connection, between a radio module connected to the microcontroller of the electronic trip element and the terminal, to transmit protection parameters of the circuit breaker that are displayable and adjustable on the terminal.

18. A method for a circuit breaker, including an electronic trip element, including a microcontroller, to interrupt at least one electrical circuit when at least one adjustable protection parameter is reached, and a terminal, the method comprising:
using a wireless connection, between a radio module connected to the microcontroller of the electronic trip element and the terminal, to transmit operating states of the circuit breaker that are displayable on the terminal.

19. A software program product for a terminal to, when executed on a device, implement the method of claim 17.

20. A software program product for a terminal to, when executed on a device, implement the method of claim 18.

21. The circuit breaker of claim 2, wherein the circuit breaker is a molded case circuit breaker.

22. The circuit breaker of claim 2, wherein the circuit breaker is an air circuit breaker.

23. The circuit breaker of claim 2, wherein the circuit breaker is a miniature circuit breaker.

24. The circuit breaker of claim 2, wherein the wireless connection is a Bluetooth connection.

25. The circuit breaker of claim 2, wherein the wireless connection is encrypted.

26. The circuit breaker of claim 2, wherein At least one of the display and adjustment of the protection parameters is safeguarded.

27. The circuit breaker of claim 3, wherein the circuit breaker is a molded case circuit breaker.

28. The circuit breaker of claim 3, wherein the circuit breaker is an air circuit breaker.

29. The circuit breaker of claim 3, wherein the circuit breaker is a miniature circuit breaker.

30. The circuit breaker of claim 3, wherein the wireless connection is a Bluetooth connection.

31. The circuit breaker of claim 3, wherein the wireless connection is encrypted.

32. The circuit breaker of claim 3, wherein At least one of the display and adjustment of the protection parameters is safeguarded.

33. A terminal comprising:
first circuitry to intermittently implement a wireless connection to at least one of a further terminal and a radio module; and
second circuitry to present data transmittable via the wireless connection, wherein the first and second circuitry are additionally embodied to interact with the circuit breaker of claim 2.

34. The terminal of claim 33, wherein the second circuitry are embodied such that the presented data are transmittable back to the circuit breaker at least in part in altered form.

35. The terminal of claim 33, wherein the second circuitry are embodied such that at least one of the presentation of the data and alteration of the data are realized by a software program product.

36. The terminal of claim 33, wherein the terminal is a mobile terminal.

37. The terminal of claim 33, wherein the terminal is a static terminal.

38. A terminal comprising:
first circuitry to intermittently implement a wireless connection to at least one of a further terminal and a radio module; and
second circuitry to present data transmittable via the wireless connection, wherein the first and second circuitry are additionally embodied to interact with the circuit breaker of claim 3.

39. The terminal of claim 38, wherein the second circuitry are embodied such that the presented data are transmittable back to the circuit breaker at least in part in altered form.

40. The terminal of claim 38, wherein the second circuitry are embodied such that at least one of the presentation of the data and alteration of the data are realized by a software program product.

41. The terminal of claim 38, wherein the terminal is a mobile terminal.

42. The terminal of claim 38, wherein the terminal is a static terminal.
